(19) United States
(12) Patent Application Publication
(10) Pub. No.: US 2009/0056115 A1
(43) Pub. Date: Mar. 5, 2009

(54) Heat Indicating Electrical Wall Fixture Gripping Testing and Installation Device

(76) Inventors: Bryan Cahill, Lindsay, CA (US); Deborah Unser, Lindsay, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 12/248,808

(22) Filed: Oct. 9, 2008

Related U.S. Application Data
(63) Continuation-in-part of application No. 11/303,312, filed on Dec. 16, 2005.
Application No. 11/303,312 is a continuation-in-part of application No. 10/961,358, filed on Oct. 7, 2004, now Pat. No. 7,302,753.
Application No. 10/961,358 is a continuation of application No. 10/171,014, filed on Jun. 12, 2002, now Pat. No. 7,032,297.
Application No. 10/171,014 is a continuation of application No. 29/160,095, filed on May 3, 2002, now Pat. No. D483682.
Application No. 29/160,095 is a continuation-in-part of application No. 29/146,415, filed on Aug. 9, 2001, now Pat. No. D459666.

(51) Int. Cl. B23P 19/00

(52) U.S. Cl. 29/745; 29/729; 29/758; 29/764; 29/747

(57) ABSTRACT

A method and apparatus for the safe and easy installation, inspection, and maintenance of wall-mounted electrical outlets and switches utilizing a multi-functional tool. Two different but similar tools are provided, each in the form of an insulated handle that may be detachably engaged with either a wall socket or a wall switch. The wall socket device includes one or more prongs for temporary engagement with slots in the socket fixture, and may include testing circuitry. The wall switch device is temporarily attached to a switch fixture using one or more magnets. Both tools may also include built-in electrical wire measuring, stripping and bending structures, as well as electrical power sensors and means for indicating the temperature of the outlet or switch.

### RELATED APPLICATIONS

This application is a continuation-in-part of co-pending application Ser. No. 11/303,312, filed on Dec. 16, 2005, which is a continuation-in-part of application Ser. No. 10/961,358, filed on Oct. 7, 2004, which issued as U.S. Pat. No. 7,302,753 on Dec. 4, 2007, which was a continuation of application Ser. No. 10/171,014, filed on Jun. 12, 2002, which issued as U.S. Pat. No. 7,032,297 on Apr. 25, 2006, which claimed the benefit of application number 29/160,095, filed on May 3, 2002, which issued as U.S. Pat. No. D483,682 on Dec. 16, 2003, which was a continuation-in-part of application number 29/146,415, filed on Aug. 9, 2001, which issued as U.S. Pat. No. D459,666 on Jul. 2, 2002, each of which are hereby incorporated by reference in their entirety.

### BACKGROUND OF THE INVENTION

1. Field of the Invention

The present invention relates to installation and repair of electrical outlets and switches in buildings, and more particularly to a method and apparatus for holding, testing and installing wall-mounted electrical outlets and switches while simultaneously detecting whether the fixture is generating excess heat.

2. Description of the Prior Art

Wall-mounted electrical fixtures (including outlets and switches) are installed every day during new construction, remodeling and repair of homes, offices, warehouses, residential and commercial structures, and other buildings. A typical wall switch or outlet is installed in a junction box that is attached to the frame that supports the wall. Wires are installed that run from an electrical power source such as a circuit breaker or fuse box, through the frame to the junction box that will hold the outlet or switch. Eventually, a point is reached during construction where power is available to be supplied through the wires that run to the electrical outlet and switch boxes. Once power is available, the electrical outlet fixtures and switches may be installed in the junction boxes and tested to confirm that they are working properly.

Wall Socket. Installing an electrical outlet or wall socket generally requires connecting the hot (black), neutral (white) and ground (green/bare) wires to the outlet fixture itself, testing the fixture to confirm that the connections are correct and that it is receiving power, attaching the fixture to the junction box, and eventually attaching a cover plate over the fixture. The most common fixtures include at least one pair of screws or terminals to which the hot and neutral wires are attached. Other fixtures include at least one pair of locking terminal openings into which the stripped, straight hot and neutral wires may be inserted. These openings may be provided instead of or in addition to screws. Wires that are inserted into these terminal openings cannot be easily removed unless an adjacent locking tab is depressed to release them. Virtually all outlet fixtures include a metallic mounting portion for attaching the fixture to the junction box. A separate green-colored grounding terminal is generally provided in the form of a screw on the metallic portion, allowing for attachment of the ground wire to ground the fixture to the junction box.

An electrician ordinarily uses a wire stripper and/or crimping tool to strip and, if necessary, bends the wires prior to attachment to the outlet fixture. A screwdriver is also required to tighten the wire screws, to attach the fixture to the box, and to install the cover plate over the fixture. The fixture must be handled carefully once the hot and neutral wires have been attached in order to avoid an electric shock. This often requires the use of a separate pair of pliers having insulated handles. The electrician then uses one hand to hold the fixture against the junction box with the pliers, while using the other hand to attach the fixture to the box using a screwdriver. This can be cumbersome because of the bulky configuration of the fixture, particularly in those cases where the pliers and screwdriver are using the same region on the fixture. For easier handling, in order to save time and to avoid the use (and possible misplacement) of an extra tool, many installers forego the use of any tool to hold the connected fixture, and instead run the risks associated with handling a “hot” socket fixture without insulation. This, of course, is dangerous and should be avoided if at all possible.

Wall socket testing devices have been developed in the prior art, such as those disclosed in U.S. Pat. Nos. 4,034,284; 4,164,702 and 6,218,844 having prongs for insertion into the slots of the wall socket to determine whether the hot and neutral wires have been connected correctly. U.S. Pat. No. 5,168,235 discloses a tool for testing and manipulating electrical outlets. All of these devices are bulky, and none of them include any handle for simple, efficient removal of the device from the socket. Moreover, no known device provides the stripping and wire bending function in the same tool used for manipulation and testing of the wall socket.

It is therefore desirable to provide a single tool for use in installing a wall socket that may be detachably engaged with the socket, that has a convenient insulated handle for easy manipulation of the socket without any danger of electrical shock, and that also includes a means for measuring and stripping the ends of the wires, a means for bending the ends of the wires, and a means for testing the socket after the wires have been attached.

Wall Switch. Installing an electrical wall switch also requires connecting the hot, neutral and ground wires to the switch fixture itself, testing the fixture, attaching it to the junction box, and eventually attaching a cover plate. As with wall sockets, most switch fixtures include a pair of screws or terminals to which the hot and neutral wires are to be attached. Newer fixtures may include a pair of locking terminal openings into which the stripped, straight hot and neutral wires may be inserted, instead of or in addition to the screw terminals. And virtually all wall switches also include a metallic mounting portion for attaching the fixture to the junction box. A separate green-colored grounding terminal is provided in the form of a screw on this metallic portion for attachment of the ground wire to ground the fixture to the junction box.

As with wall sockets, the electrical wires must be stripped, and in some cases bent prior to attachment to the switch fixture. Then the fixture must be handled carefully in order to avoid an electric shock. An electrician faces installation problems similar to those of a wall socket, in that one hand is used to hold the fixture against the junction box with a pair of pliers, while the other hand is used to attach the fixture to the box using a screwdriver. Should the installer forego the use of an insulated tool to hold the connected fixture, (s)he faces the risks associated with handling a “hot” socket fixture without insulation. In this regard, it is useful to know whether power is being supplied to the switch fixture.

Since there are no slots on ordinary wall switch fixtures, the testing and manipulation devices that have been developed in the prior art for wall sockets cannot be used with wall switches. No known devices exist that allow a user to detachably engage a wall switch for manipulation and insulation prior to and during installation. Nor are any devices known to exist which provide the added functions of stripping and if necessary bending the wires prior to attachment to the switch, nor sensing whether the switch fixture is “hot.”

It is therefore desirable to provide a single tool for use in installing a wall switch that may be detachably engaged with the switch, that has a convenient insulated handle for easy manipulation of the switch without any danger of electrical shock, and that also optionally includes a means for measuring and stripping the ends of the wires, and/or a means for bending the ends of the wires, and/or a sensor for detecting whether power is being supplied to the switch fixture.

Heat indicating. Although an electrical fixture may have been installed with due care by a properly trained electrician, it may still require occasional and ongoing maintenance. Similar to recommended periodic performance checks of smoke detectors, it is recommended that electrical outlets and switches be inspected yearly for early signs of degradation. In residential installations, the fixtures may deteriorate for any number of reasons, including among other things: frequent usage, abuse, physical disturbance or damage, the use of improper plugs, circuit overloading, over insulation, improper installation, humidity, lack of maintenance, aging, damage due to insects and rodents, and exposure to weather.

Unfortunately, many home owners do not perform such periodic inspections based on an erroneous belief that the electronic wiring and fixtures in the home will last an indefinite time. The misunderstanding can be grave—many electrical problems do not substantially manifest themselves until it is too late. Each year, approximately 40,000 reported home fires are attributed to issues with the electrical systems. The Consumer Product Safety Commission estimates that 5,300 fires were attributable to electrical fixtures in 2003 wherein 40 lives were lost. In addition, they estimate that there are 3,900 injuries associated with electrical fixtures which require emergency room visits each year. The need for a device to aid in the inspection, installation, maintenance, and detection of potentially faulty electrical plugs and switches has become clear.

Deteriorating electrical fixture can be evidenced in many ways: visible arcing or sparking, audible cracking or buzzing sounds, frequent circuit breaks, exposed metal, lose or broken parts, or temperature related indicia. The presence of smoke or other “hot” smell, discoloration or melting of the plate covers, and warm or receptacles that are warm or hot to the touch may indicate that the fixture has deteriorated and should be serviced or replaced. Excessive heat is frequently caused by improper installation (including over tightening or under tightening of the wires attached to the fixture), warn receptacle springs due to overuse, and the drawing of power in excess of the fixtures rating (for example, the use of a light bulb in excess of the rated wattage).

It is therefore desirable to provide a single tool which, in accordance with the proceeding desired features, includes a means for indicating whether the electrical fixture is generating excess heat.

### SUMMARY OF THE INVENTION

The present invention provides a method and apparatus for the safe and easy installation and testing of wall-mounted electrical outlets and switches utilizing a multi-functional tool. Two different but similar tools are provided, one for use in connection with the installation and testing of wall sockets, and the other for use in connection with the installation and testing of wall switches. Both tools are in the form of insulated handles that may be detachably engaged with either a wall socket or a wall switch, and both tools may include built-in wire measuring, stripping and bending devices as well as a built-in electrical power sensor and means for indicating the temperature of the socket or switch.

In the wall socket aspect of the apparatus, one or more prongs are provided which correspond with at least one of the hot, ground and/or neutral slots of the wall socket fixture to be installed. These prong(s) are integrated into a convenient insulated handle that allows the user to firmly grip the handle for attachment and removal of the apparatus from the socket fixture. Attaching the apparatus to the socket fixture allows the fixture to be easily manipulated using the handle without fear of electrical shock. The handle may have any suitable configuration, and is sized such that the mounting slots and screws at both ends of the socket are easily accessible for attachment to the mounting tabs on the junction box.

In one embodiment of the wall socket manipulation handle, a recessed slot is provided in the top of the handle or at some other suitable location on the device, and a blade is provided which partially protrudes into the slot. Measurement indicia are provided on the side of the handle below the slot or at some other suitable location on the device. The bladed slot is used for stripping the wires to be attached to the fixture, and the measurement indicia are used for establishing the gauge or length of the wire to be stripped. By using the measurement indicia to select the position for the wire in the slot, the wire may be inserted into the slot and rotated against the blade to strip off the correct amount of insulation from the wire so that it may be attached to the fixture. A pre-measured hole is also provided in this embodiment into which the stripped wire may be easily inserted so that it may be bent over in order to fit over the screw terminals of the fixture.

In another embodiment of the wall socket manipulation device, testing lights, an electronic sensor, or other means are provided in the device to detect the present of electrical power, and to confirm that the socket has been properly connected to the electrical wiring.

In other embodiments, the wall socket manipulation device may include means for indicating the temperature of the wall socket. In some embodiments, the wall socket manipulation device can include a film or other material fixed to the side of the device from which the prongs extend. The film may be configured to have a color corresponding to different temperatures or temperature ranges. In some embodiments, the film may cover the entire surface of the wall device. In other embodiments, the film may cover only a portion thereof.

In other embodiments, the wall socket manipulation device may comprise a heat sensitive plastic material. In some embodiments, the entire device may comprise heat sensitive material such that when the device is placed near or in contact with a heat source, a portion of the wall socket manipulation device may change colors. In other embodiments, the base may comprise heat sensitive material and the handle and arms of the device may comprise non-heat sensitive material. In these examples, only the base will change colors when it comes near or in contact with a heat source.

In other embodiments, a thermocouple can be provided and configured on the side of the device from which the prongs extend. In some embodiments, the thermocouple may be coupled to the prongs and configured to measure the temperature of the prongs. In other embodiments, the thermocouple may be located near, but independent from, the prongs. In some embodiments, the thermocouple may be connected to a circuit having a means for visually or audibly indicating the sensed temperature. In other embodiments, the thermocouple may be connected to the means for detecting the presence of electrical power. For example, in some embodiments, the wall socket manipulation device may include a light, coupled to both the means for detecting the presence of electrical power and the thermocouple, wherein the light is configured to indicate whether it is safe to manipulate the wall socket.

In the wall switch aspect of the apparatus, one or more magnets are provided on the base of the insulated handle for temporary attachment to the metallic portions of the switch during installation. The magnet(s) surround an opening that receives the toggle portion of the wall switch when attached to the invention. The magnet(s) and toggle switch opening are integrated into the base which is attached to a convenient handle that allows the user to firmly grip the handle for attachment and removal of the apparatus from the switch. Attaching the apparatus to the switch allows it to be easily manipulated using the handle without fear of electrical shock. The handle may have any suitable configuration, and is sized such that the mounting slots and screws at both ends of the switch are easily accessible for attachment to the mounting tabs on the junction box.

In one embodiment of the wall switch manipulation handle, a recessed slot is provided in the top of the handle or at some other suitable location on the device, and a blade is provided which partially protrudes into the slot. Measurement indicia are provided on the side of the handle below the slot or at some other suitable location on the device. The bladed slot is used for stripping the wires to be attached to the fixture, and the measurement indicia are used for establishing the gauge or length of the wire to be stripped. By using the measurement indicia to select the position for the wire in the slot, the wire may be inserted into the slot and rotated against the blade to strip off the correct amount of insulation from the wire so that it may be attached to the fixture. A pre-measured hole is also provided in this embodiment into which the stripped wire may be easily inserted so that it may be bent over in order to fit over the screw terminals of the fixture.

In another embodiment of the wall switch manipulation device, an electronic sensor, or other means for detecting the presence of electrical power in the switch fixture are provided in the device. Such a sensor may be provided independently, or with any combination of the bladed slot, and/or measurement indicia.

In some embodiments, the wall switch manipulation device may include means for indicating the temperature of the wall switch. In some embodiments, the wall socket manipulation device can include a film or other material fixed to the base of the device. The film may be configured to have a color corresponding to different temperatures or temperature ranges. In some embodiments, the film may cover the entire surface base. In other embodiments, the film may cover only a portion thereof.

In other embodiments, the wall switch manipulation device may comprise a heat sensitive plastic material. In some embodiments, the entire device may comprise heat sensitive material such that when the device is placed near or in contact with a heat source, a portion of the wall switch manipulation device may change colors. In other embodiments, the base may comprise heat sensitive material and the handle and arms of the device may comprise non-heat sensitive material. In these examples, only the base will change colors when it comes near or in contact with a heat source.

In other embodiments, a thermocouple can be provided and configured on the base of the device. In some embodiments, the thermocouple may be located near the opening for receiving the toggle portion of the wall switch. In some embodiments, the thermocouple may be connected to a circuit having a means for visually or audibly indicating the sensed temperature. In other embodiments, the thermocouple may be connected to the means for detecting the presence of electrical power. For example, in some embodiments, the wall switch manipulation device may include a light, coupled to both the means for detecting the presence of electrical power and the thermocouple, wherein the light is configured to indicate whether it is safe to manipulate the wall switch.

In some embodiments, the magnet(s) which surround the toggle switch opening may comprise a material for indicating heat. In some embodiments, the magnet(s) may have a color corresponding to different temperatures and/or temperature ranges. In some embodiments, a wall switch manipulation device may have a window or other opening for viewing a portion of the magnet(s) when the device is attached to a wall switch.

It is therefore a primary object of the present invention to provide a tool in the form of a convenient insulated handle for temporary attachment to a wall switch or socket fixture for use in manipulating said fixture during installation of the fixture to a junction box and for testing or adjusting the fixture after installation, which is capable of indicating the temperature thereof.

It is also a primary object of the present invention to provide a single tool that may be temporarily attached to a wall switch or socket fixture to facilitate easy installation of the fixture, the tool having a built-in blade and measuring indicia for use in stripping the wires to be attached to the fixture.

It is another object of the present invention to provide a tool in the form of an insulated handle having at least one prong thereon for insertion into at least one slot of a wall socket fixture allowing for temporary attachment of the handle to the fixture during installation of the fixture to a junction box.

It is another object of the present invention to provide a tool in the form of an insulated handle for temporary attachment to a wall socket fixture during installation of the fixture, the tool having a built-in blade and measuring indicia for use in stripping the wires to be attached to the fixture.

It is another object of the present invention to provide a tool in the form of an insulated handle for temporary attachment to a wall socket fixture during installation of the fixture, the tool having an opening for receiving a stripped wire that may be used to easily bend the wire for proper attachment to the fixture.

It is another object of the present invention to provide a tool in the form of an insulated handle for temporary attachment to a wall socket fixture during installation of the fixture, the tool having at least one sensor for use in detecting the presence of electrical power and/or determining whether the fixture has been properly attached to the wires.

It is another object of the present invention to provide a tool in the form of an insulated handle having an opening for receiving the toggle lever of a wall switch fixture and at least one magnet for temporary attachment to the metallic portion of the wall switch fixture during installation of the fixture to a junction box.

It is another object of the present invention to provide a tool in the form of an insulated handle for temporary attachment to a wall switch fixture during installation of the fixture, the tool having a built-in blade and measuring indicia for use in stripping the wires to be attached to the fixture.

It is another object of the present invention to provide a tool in the form of an insulated handle for temporary attachment to a wall switch fixture during installation of the fixture, the tool having a separate opening for receiving a stripped wire that may be used to easily bend the wire for proper attachment to the fixture.

It is another object of the present invention to provide a tool in the form of an insulated handle for temporary attachment to a wall switch fixture during installation of the fixture, the tool having a sensor for detecting the presence of electrical power in the switch fixture.

Additional objects of the invention will be apparent from the detailed descriptions and the claims herein.

### BRIEF DESCRIPTION OF THE DRAWINGS

FIG. 1 is a perspective view of an embodiment of the present invention showing the alignment for attachment to an electrical toggle wall switch.

FIG. 2 is an opposite side perspective view of the embodiment of FIG. 1.

FIG. 3 is a perspective view of the embodiment of FIG. 1 magnetically attached to an electrical toggle wall switch.

FIG. 4 is an end view of the embodiment of FIGS. 1-3.

FIG. 5 is a side elevational view of the embodiment of FIGS. 1-4.

FIG. 6 is a perspective view of another embodiment of the present invention showing the alignment for attachment to an electrical wall socket.

FIG. 7 is an opposite side perspective view of the embodiment of FIG. 6.

FIG. 8 is a perspective view of the embodiment of FIG. 6 frictionally attached to an electrical wall socket.

FIG. 9 is an end view of the embodiment of FIGS. 6-8.

FIG. 10 is a side elevational view of the embodiment of FIGS. 6-9.

FIG. 11 is a perspective view of an embodiment of the present invention showing the battery cavity of the invention.

FIG. 12 is an opposite side perspective view of the embodiment of FIG. 11.

FIG. 13 is a top plan view of the embodiment of FIGS. 11-12.

FIG. 14 is a bottom plan view of the embodiment of FIGS. 11-13.

FIG. 15 is an end view of the embodiment of FIGS. 11-14.

FIG. 16 is a side elevational view of the embodiment of FIGS. 11-15.

FIG. 17 is an opposite end view of the embodiment of FIG. 15.

FIG. 18 is a perspective view of an embodiment of the present invention showing the alignment for attachment to an electrical toggle wall switch.

FIG. 19 is a perspective view of an embodiment of the present invention magnetically attached to an electrical toggle wall switch.

FIG. 20 is a side cross-sectional elevational view of the embodiment of FIGS. 11-19 magnetically attached to an electrical toggle wall switch.

FIG. 21 is an end cross-sectional elevational view of the embodiment of FIGS. 11-20 magnetically attached to an electrical toggle wall switch.

FIG. 22 is a top view of an embodiment of the present invention having a “T” shaped handle.

FIG. 23 is a bottom view of the embodiment of FIG. 22.

FIG. 24 is an end elevational view of the embodiment of FIGS. 22-23.

FIG. 25 is a side elevational view of the embodiment of FIGS. 22-24.

FIG. 26 is an opposite end elevational view of the embodiment of FIG. 24.

FIG. 27 is a perspective view of a temperature indicating magnet for use with an electrical wall switch in accordance with embodiments of the present invention.

FIG. 28 is an opposite side perspective view of the embodiment of FIG. 27.

FIG. 29 is a perspective view of a temperature indicating thermocouple for use with an electrical wall socket in accordance with embodiments of the present invention.

FIG. 30 is an opposite side perspective view of the embodiment of FIG. 29.

FIG. 31 is a perspective view of a temperature indicating thermocouple for use with an electrical wall switch in accordance with embodiments of the present invention.

FIG. 32 is an opposite side perspective view of the embodiment of FIG. 31.

FIG. 33 is a perspective view of an internal temperature indicating thermocouple for use with an electrical wall socket in accordance with embodiments of the present invention.

FIG. 34 is an opposite side perspective view of the embodiment of FIG. 33.

FIG. 35 is a perspective view of a thermochromic liquid crystal adhesive strip in accordance with embodiments of the present invention.

FIG. 36 is a perspective view of another thermochromic liquid crystal adhesive strip in accordance with embodiments of the present invention.

FIG. 37 is a perspective view of a thermochromic compound in accordance with embodiments of the present invention.

FIG. 38 is an opposite side perspective view of the embodiment of FIG. 37.

FIG. 39 is a perspective view of another thermochromic compound in accordance with embodiments of the present invention.

FIG. 40 is an opposite side perspective view of the embodiment of FIG. 39.

### DETAILED DESCRIPTION OF A PREFERRED EMBODIMENT

The insulated manipulation handle of the present invention will be described herein with reference to the mounting and installation of conventional wall sockets and switches as illustrated. However, it is to be understood that embodiments of the present invention may be used for installation of many different kinds of wall sockets and/or switches having different slot configurations, different numbers and shapes of toggle levers, etc.

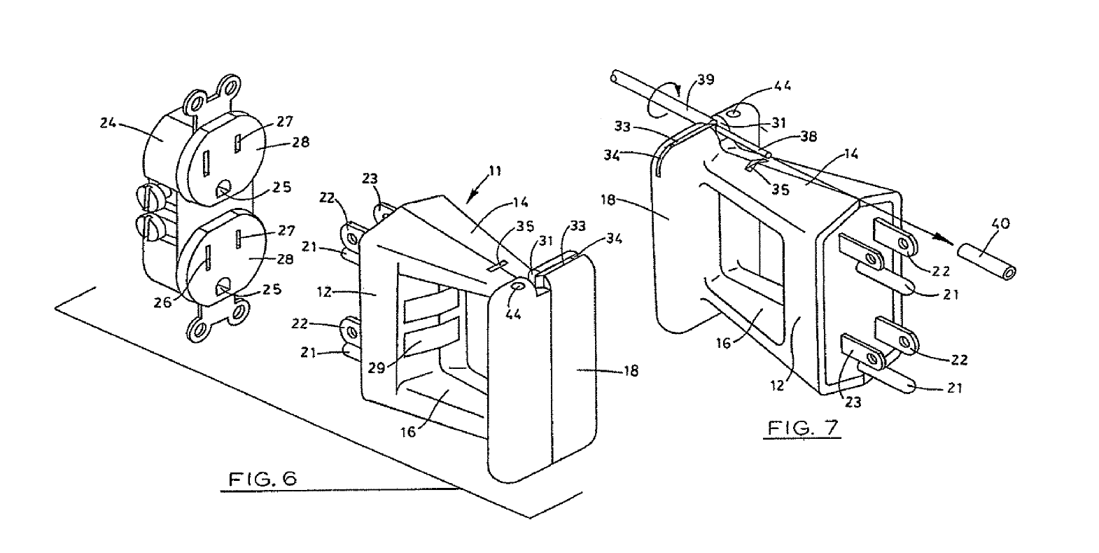

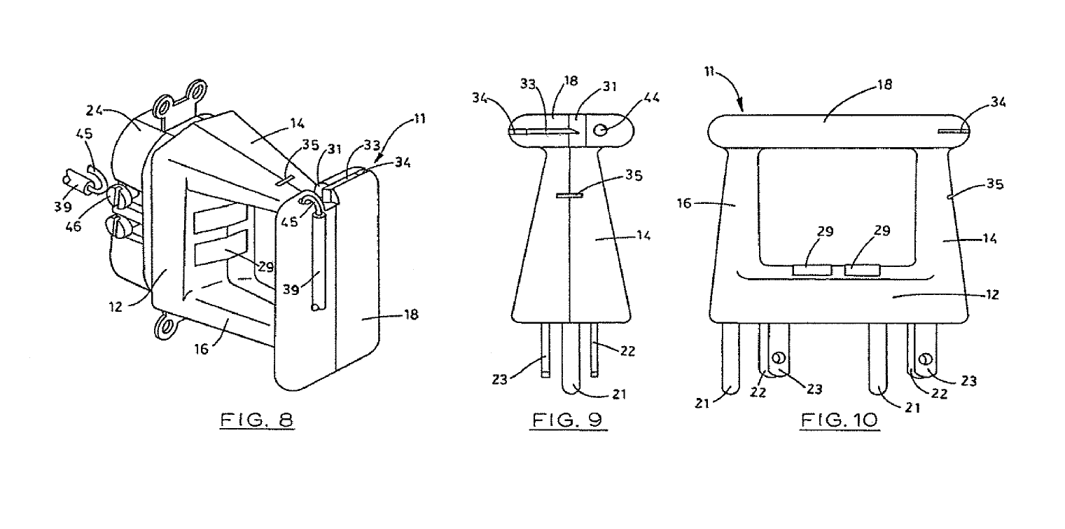

Referring to the drawings wherein like reference characters designate like or corresponding parts throughout the several views, and referring particularly to FIGS. 6-10 it is seen that the embodiment of the present invention suitable for installation of wall socket fixtures includes an insulated integral handle portion, generally 11, made up of a base 12 having proximal and distal support arms 14 and 16 connected between the base 12 and a hand grip 18. Support arms 14 and 16 are located at opposite ends of base 12 and grip 18 defining a wide opening in the center of the handle 11. This opening provides a space for the user's fingers when holding the handle. Grip 18 is illustrated in the form of a tabletop, but may have any shape that is suitable for gripping by hand.

In the embodiment designed for manipulation of a wall socket fixture, one or more prong(s) 21 are provided on the outside edge of base 12 for snug insertion into one or more of the slot(s) 25 of the socket fixture 24. In the illustrated embodiment, two complete sets of three prongs are shown, corresponding to both of the sockets of the fixture. However, for manipulation purposes, any number and/or combination of prongs may be used, ranging from a single prong for a single socket to a complete set of prongs for all sockets.

In another embodiment, a complete set of prongs 21-23 are provided for each socket 28 for testing purposes, the prongs 21-23 of each set corresponding to the slots 25-27 of each socket 28 of the fixture 24. Circuitry (not illustrated) inside the handle connects the prongs 22 and 23 of each set to an indicator signal such as window 29 that illuminates upon insertion of the prongs into the slots, if the fixture 24 has been properly connected to the power source. Alternatively, a sound activated signal may be provided. Additional circuitry and indicator signals (not illustrated) may be provided to confirm more specific information such as the proper attachment of hot, neutral and ground wires for each socket.

It is to be understood that different numbers, sizes and arrangements of prongs may be provided on handle 11 corresponding to different socket slot configurations, including without limitation and for illustrative purposes only, 220 volt fixtures, European fixtures, various A/C and D/C fixtures, and the like.

In one embodiment, a wire stripper is provided in grip 18. The wire stripper is in the form of a slot 31 located at a peripheral edge of the grip 18. A removable and replaceable blade 33 is provided in another thinner slot 34 on the same peripheral edge of grip 18 such that the sharp edge of blade 33 protrudes part way into slot 31. No portion of blade 33 extends beyond the peripheral profile of grip 18, thereby minimizing the possible infliction of cuts to the user during handling. Measuring indicia such as cut 35 are provided on the support arm (14, in the illustration) adjacent to slot 31 for use in determining the length of the portion of the wire to be stripped. While a single cut 35 is illustrated, it is to be understood that any suitable measuring indicia may be provided including without limitation a series of spaced cuts, printed measurements in either metric or English, or other indicia. The size of slot 31 and the position of blade 33 therein may vary according to the gauge of wire expected to be used with the invention.

Using the measuring indicia 35, a wire having an inner metallic core 38 and an outer insulated sleeve 39 is inserted into slot 31 such that blade 33 pierces the insulated sleeve 39 as shown in FIG. 7. Then, either the invention 11 is rotated around the wire, or the wire rotated inside slot 31, resulting in the blade 33 stripping of a portion of the insulation 40 from the wire.

A hole 44 may also be provided on grip 18 for bending the stripped portion 38 of the wire for attachment to the screws of the fixture. Hole 44 is sized such that the width of the hole 44 is the same as the gauge of the wire to be used. The depth of hole 44 is set such that the stripped portion of the wire may be fully inserted into the hole and bent over as shown in FIG. 8 to form an arc 45 that is easily attached around a screw on the fixture.

In use, the prongs 21-23 of the insulated handle 11 are temporarily inserted into the slots 25-27 of a wall socket fixture 24. The fixture 24 may then be manipulated into any convenient position using the handle 11. Wires may be stripped and bent using the stripping slot and bending hole in the grip of the handle. These wires may then be attached to the fixture while it is still engaged with the handle, and the indicator signals used to confirm proper attachment. Finally, the fixture may be held in place using the handle while the fixture is installed into the junction box. Following such installation, the handle is detached from the fixture. Thus, the unique handle 11 of the present invention greatly simplifies the stripping and attachment of wires to a wall socket fixture as well as the installation of the fixture into a junction box, while avoiding unnecessary exposure to electric shock.

Referring to the embodiment of FIGS. 1-5 of the drawings, it is seen that the embodiment of the present invention suitable for installation of wall switch fixtures also includes insulated integral handle portion, generally 11, made up of a base 12 having proximal and distal support arms 14 and 16 connected between the base 12 and a hand grip 18. Support arms 14 and 16 are located at opposite ends of base 12 and grip 18 defining a wide opening in the center of the handle 11. This opening provides a space for the user's fingers when holding the handle. Grip 18 is illustrated in the form of a tabletop, but may have any shape that is suitable for gripping by hand.

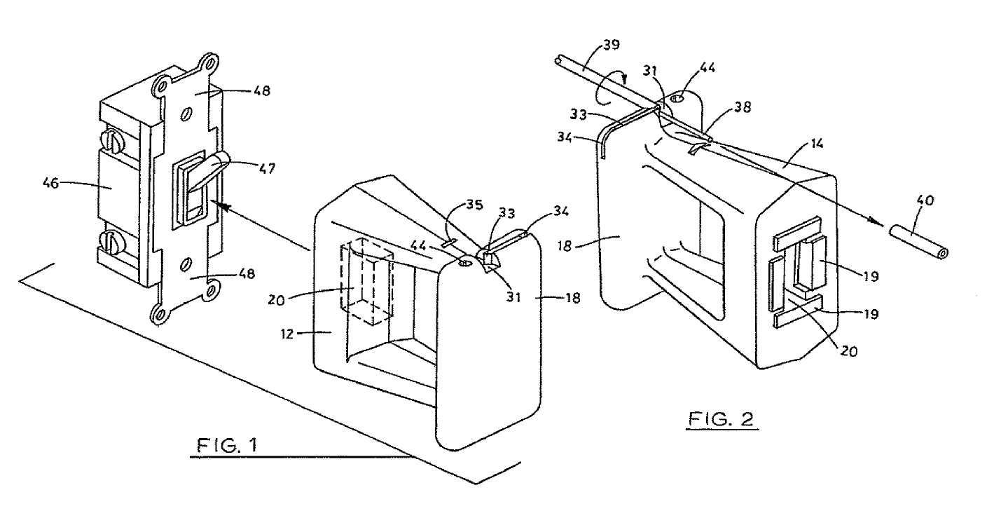

In the embodiment designed for manipulation of a wall switch fixture, one or more magnets 19 are provided are provided on the outside edge of base 12 for temporary but firm attachment to the metallic portions 48 of the wall switch fixture 46. A large slot 20 is provided on the outside edge of base 12 for receiving the toggle lever 47 of the switch. Slot 20 is surrounded by magnets 19. It is to be appreciated that while the embodiment illustrated in FIG. 2 shows four magnets, a single magnet 19 is sufficient to accomplish the temporary attachment required by the invention, and that such single magnet 19 may be provided at either end or on either side of slot 20. Alternatively, any number of magnets 19 may be employed near or around slot 20, or a single magnet in the form of a frame that surrounds opening 20 may be used.

In one embodiment, a wire stripper is provided in grip 18. The wire stripper is in the form of a slot 31 located at a peripheral edge of the grip 18. A removable and replaceable blade 33 is provided in another thinner slot 34 on the same peripheral edge of grip 18 such that the sharp edge of blade 33 protrudes part way into slot 31. No portion of blade 33 extends beyond the peripheral profile of grip 18, thereby minimizing the possible infliction of cuts to the user during handling. Measuring indicia such as cut 35 are provided on the support arm (14, in the illustration) adjacent to slot 31 for use in determining the length of the portion of the wire to be stripped. While a single cut 35 is illustrated, it is to be understood that any suitable measuring indicia may be provided including without limitation a series of spaced cuts, printed measurements in either metric or English, or other indicia. The size of slot 31 and the position of blade 33 therein may vary according to the gauge of wire expected to be used with the invention.

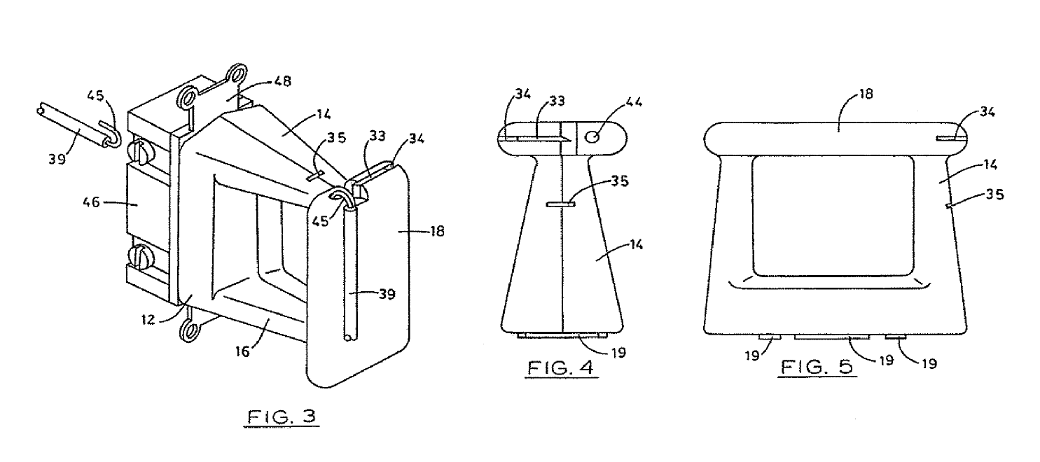

Using the measuring indicia 35, a wire having an inner metallic core 38 and an outer insulated sleeve 39 is inserted into slot 31 such that blade 33 pierces the insulated sleeve 39 as shown in FIG. 2. Then, either the invention 11 is rotated around the wire, or the wire rotated inside slot 31, resulting in the blade 33 stripping of a portion of the insulation 40 from the wire. A hole 44 may also be provided on grip 18 for bending the stripped portion 38 of the wire for attachment to the screws of the fixture. Hole 44 is sized such that the width of the hole 44 is the same as the gauge of the wire to be used. The depth of hole 44 is set such that the stripped portion of the wire may be fully inserted into the hole and bent over as shown in FIG. 3 to form an arc 45 that is easily attached around a screw on the fixture.

In use, the magnets 19 of the insulated handle 11 are temporarily attached to the metallic portion 48 of the wall switch fixture 46. The fixture 46 may then be manipulated into any convenient position using the handle 11. Wires may be stripped and bent using the stripping slot and bending hole in the grip of the handle. These wires may then be attached to the fixture while it is still engaged with the handle. Finally, the fixture may be held in place using the handle while the fixture is installed into the junction box. Following such installation, the handle is detached from the fixture. Thus, the unique handle 11 of the present invention greatly simplifies the stripping and attachment of wires to a wall switch fixture as well as the installation of the fixture into a junction box, while avoiding unnecessary exposure to electric shock.

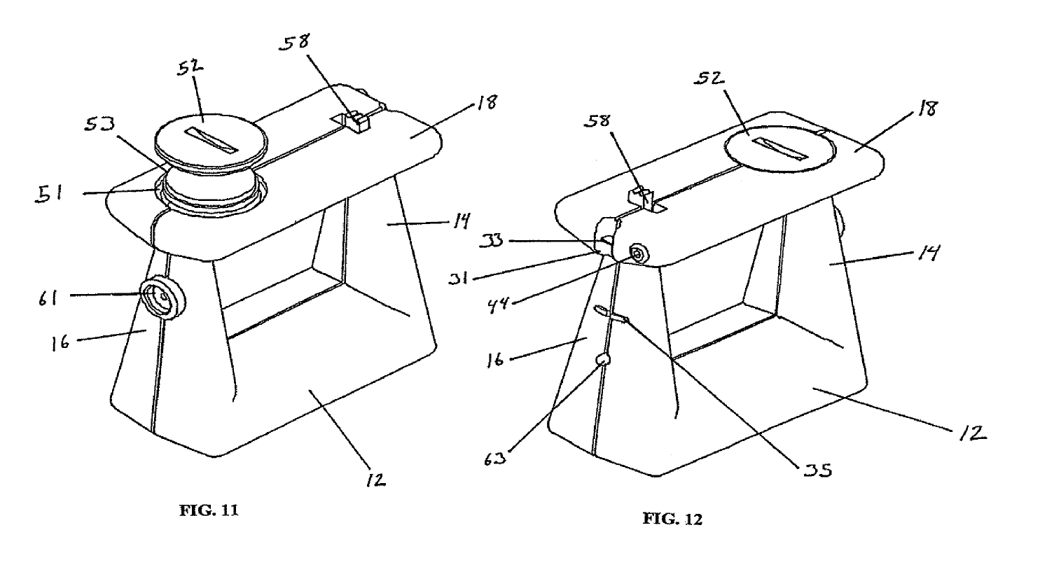

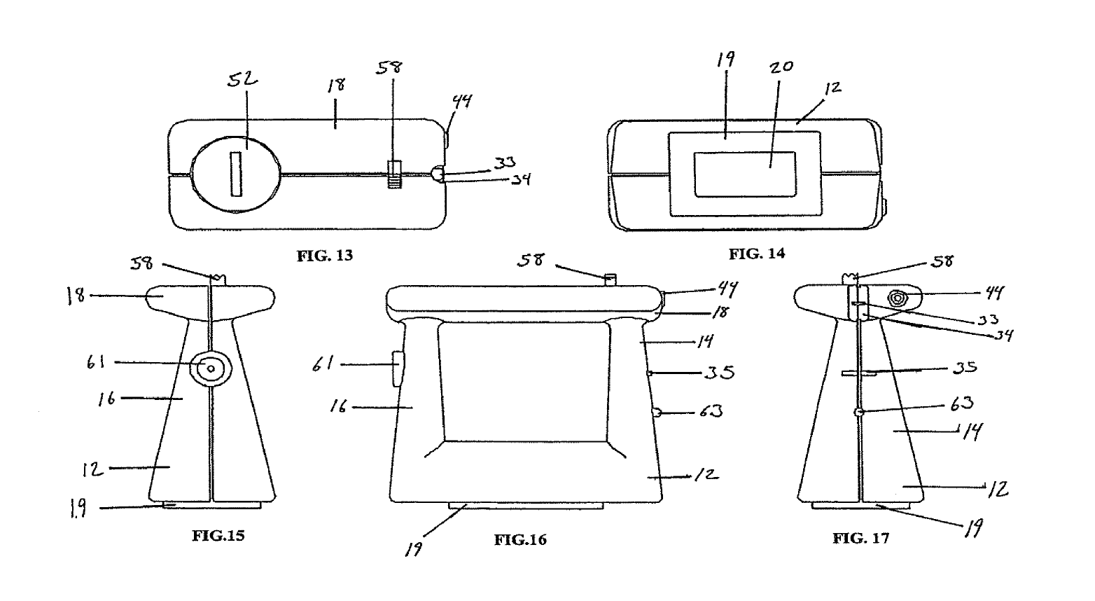

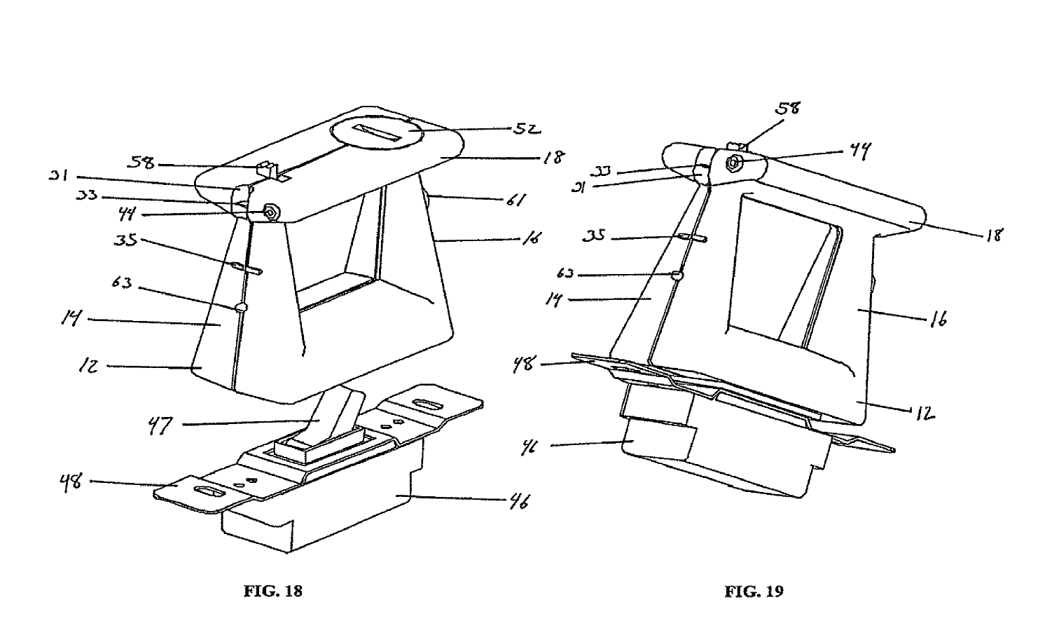

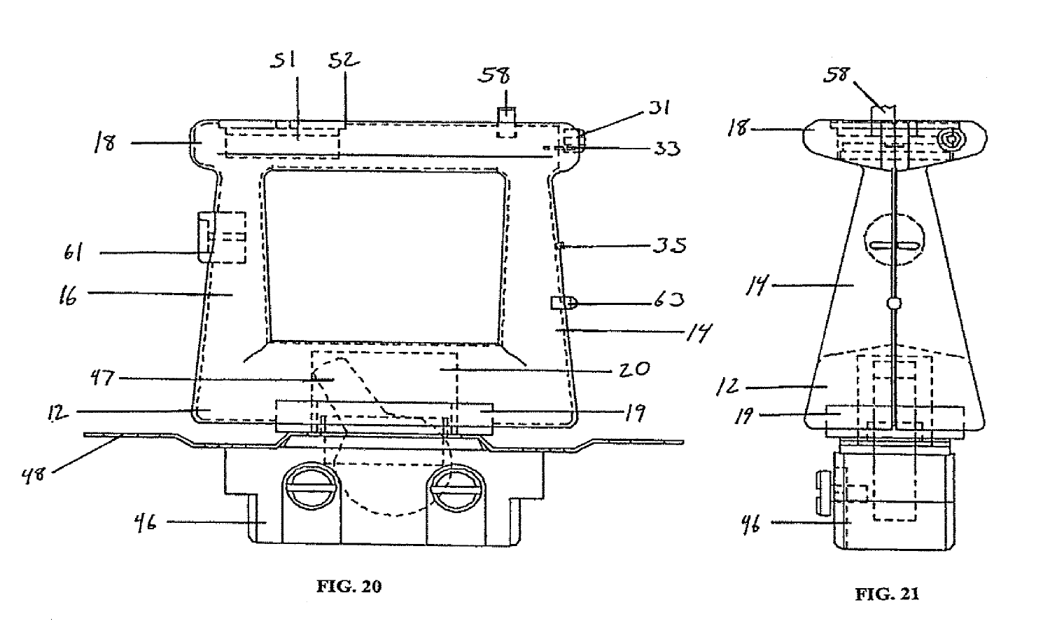

In another embodiment, pictured in FIGS. 11-21, a non contact voltage sensor is incorporated into the apparatus. Non-contact voltage sensors are commonly known in the art. Such devices detect voltage from a live current without any direct contact to the carrier of the current. In this case, a sensor can be incorporated in the device where the sensitivity of the sensor is appropriate so that the sensor will detect when live wires are attached to the wall switch fixture. The sensor is to be used when the apparatus is firmly attached to a wall switch fixture 47 by the use of magnetic force. When the user connects the proper wiring to the wall socket fixture 47 and power is supplied though the wires, the sensor will detect that power is being supplied to the wall switch fixture 47. This will alert the user that the fixture 47 is properly wired, and moreover that the light switch fixture has live current running through it and caution should be used to avoid electric shock.

The non-contact voltage sensor requires a power source, such as a battery 53, an on/off switch 58, a warning light 63 and buzzer 61, and circuitry (not shown). With regard to the power source for the sensor, battery(ies) 53, can be used. Alternative power supplies commonly know in the art such as solar power can be used. Batteries are to be placed in a cavity 51 to power voltage sensors integrated in the invention. A detachable battery cavity lid 52 is used to keep the battery from being dislodged. A battery 53 is placed in the cavity 51. When the lid 52 is fastened with the battery 53 in place, the battery is in contact with conductors to provide power to a circuit to the sensor. In a preferred embodiment, the battery 53 is a watch and/or hearing aid style battery due to size and longevity. Alternatively, any standard battery can be used. The placement of the battery cavity 51 in the grip 18 is not essential. In other embodiments, the battery cavity 51 can be placed in the base 12, distal support arms 14, 16, support post 50. The battery cavity lid can be detachably fixed by being snapped into place, screwed into place, or any other manner commonly known in the art.

The embodiment depicted in FIGS. 11-19 also includes a switch 58 on the grip 18. The switch 18 functions to turn on and off the non-contact voltage sensor system integrated in the invention. Power to the sensor system is supplied from a battery 53. To prevent the battery from draining, the sensor system can be turned off using the switch 58.

A sensor indicator light 63 is powered by the battery and becomes lit when the non-contact voltage sensor detects a voltage current in the switch fixture to which the apparatus is mounted. When the sensor detects voltage running through the switch fixture, the sensor device can alert the user in one of many ways. The light 63 may rapidly flash on and off, the light may stay continually lit when the sensor detect a current, or any other method where the user would easily recognize that a current has been found. Additionally, the buzzer 61 can beep, make a continuous sound, different sounds, or any combination thereof to properly alert the user.

The embodiment of FIGS. 11-21 functions in the same manner of described above for attaching to and installing a wall switch fixture 46. While the embodiment shown is depicted with non-contact sensor, the embodiment could contain any combination of a non-contact sensor, wires stripper, and wire bender.

In other embodiments, the device for manipulating an electrical wall switch fixture can include an insulated integral handle made up of a base, the base having at least one opening for receiving a toggle lever of the wall switch, and at least one magnet for temporary engagement with the switch fixture. In some embodiments, a wire stripping slot may be provided, and a replaceable blade can be provided adjacent to the slot such that a sharp edge of the blade partially protrudes into the slot for engagement with an insulated sleeve of a wire to be stripped.

In some embodiments, measuring indicia may provided for use in determining the length of a wire to be stripped. In other embodiments, a replaceable blade can be provided adjacent to the slot such that a sharp edge of the blade partially protrudes into the slot for engagement with an insulated sleeve of the wire to be stripped.

In some embodiments, an electricity sensor can be provided on the base, and wiring can be provided inside the base connecting the sensor to the wall switch fixture such that the sensor is triggered by the proper completion of a circuit through the switch fixture.

In other embodiments, a wire stripping slot can be provided, and a replaceable blade can be provided adjacent to the slot such that a sharp edge of said blade partially protrudes into the slot for engagement with an insulated sleeve of a wire to be stripped. In some embodiments measuring indicia can be provided for use in determining the length of a wire to be stripped. In other embodiments, a wire stripping slot can be provided, and a replaceable blade can be provided adjacent to the slot such that a sharp edge of the blade partially protrudes into the slot for engagement with an insulated sleeve of the wire to be stripped.

In some embodiments, the insulated integral handle further can include a hand grip extending from the base. In some embodiments, the hand grip can be connected to the base by a support arm. In some embodiments, the hand grip can extend outwardly in a perpendicular direction from the support arm. In accordance with some embodiments, the combination of the hand grip and support arm can generally be “T” shaped.

In other embodiments, the insulated integral handle can further include a hand grip extending from the base. In other embodiments, the hand grip can be connected to the base by a support arm. In some embodiments, the hand grip can extend outwardly in a perpendicular direction from the support arm. In other embodiments, the combination of the hand grip and support arm are generally “T” shaped.

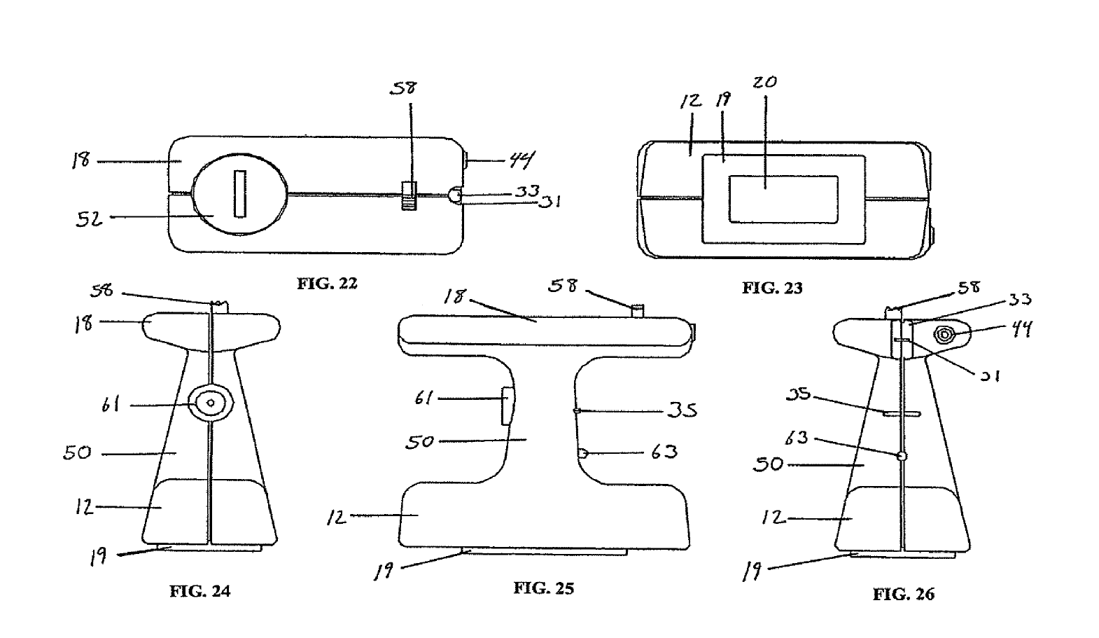

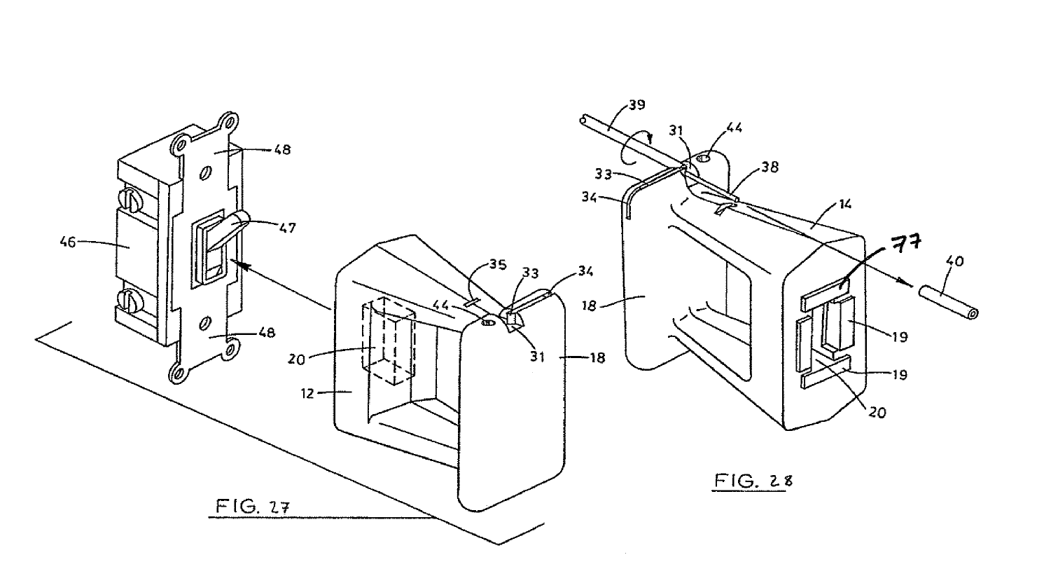

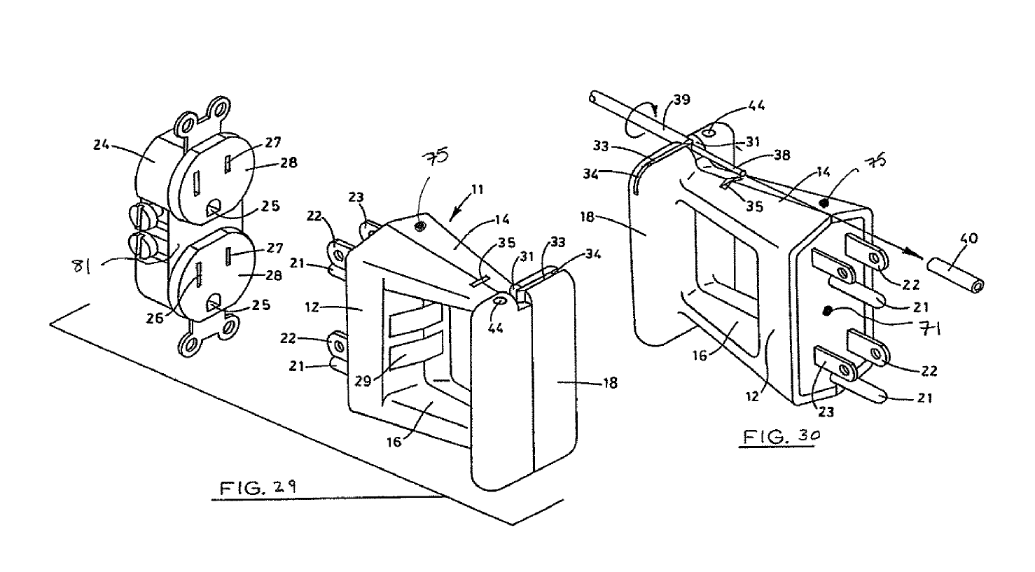

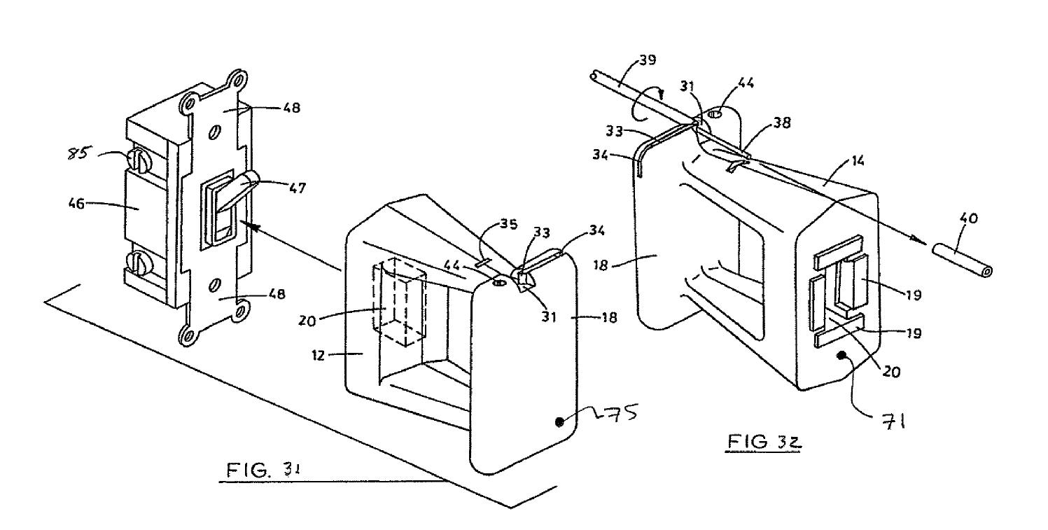

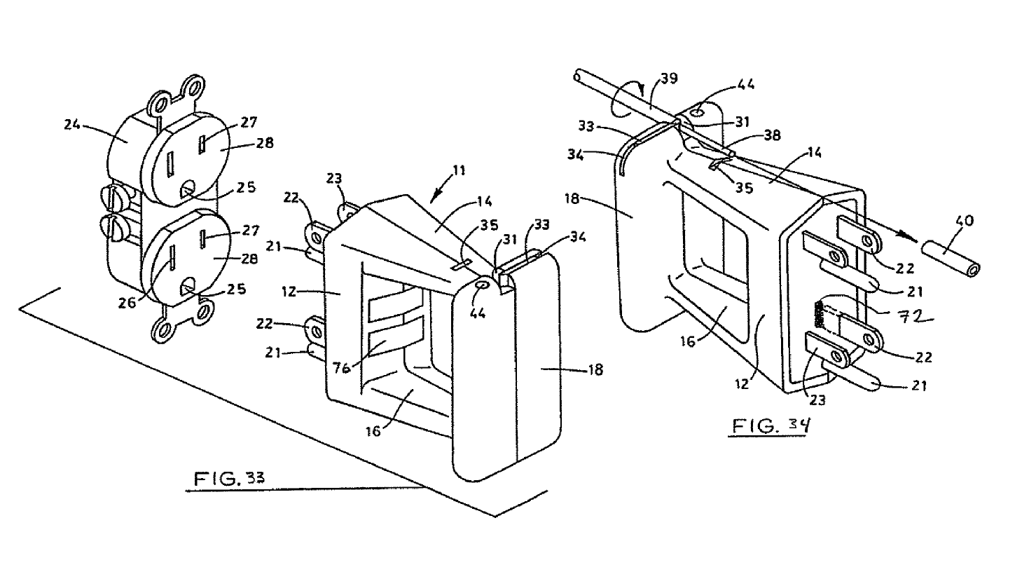

In an alternative embodiment depicted in FIGS. 22-26, the device is shown having a single support post 50 to attach the grip 18 to the base 12. The device still works in the same function, and the grip 18 is still comfortable to hold as the support post fits between the user's fingers. All of the elements of the embodiments above including, but not limited to, the wire stripper 31, 33, wire bender 44, and non-contact voltage sensor can be incorporated in this embodiment. The preferred embodiment as shown has the support post extending from the center of the base. In alternative embodiments, the support post 50 need not extend from the center of the base 12, and also need not connect to the center of the grip 18. Any configuration of the support post 50 and grip 18 that does not interfere with the installation of the switch fixture can be used. It should also be noted that the measuring indicia 35 need not be located on the support post 50, and can be located on any convenient place on the apparatus.

In some embodiments the device can include an insulated base having a means for temporarily attaching the device to an electrical wall fixture, an insulated hand grip coupled to the base, and a means for indicating the temperature of the electrical wall fixture. As shown in exemplary drawings, an electrical wall fixture can be an electrical wall socket fixture or an electrical wall switch fixture. In some implementations, the base of the device can be configured, as shown in the exemplary FIGS. 6-10, such that the device is suitable for maintenance of wall socket fixtures. In other implementations, the base of the device can be configured, as shown in the exemplary FIGS. 1-5, such that the device is suitable for maintenance of wall switch fixtures. However, it is to be understood that embodiments of the present invention may be sued for installation, manipulation, testing, etc. of many different kinds of electrical wall fixtures having different receptacle or slot configurations, different number and types of toggle levers, and the like. In some embodiments, the hand grip can be configured to be connected to the base via a pair of support arms, as shown in the exemplary FIGS. 1-26. In other embodiments, the hand grip can be configured to be connected to the base via a support post extending from the center of the base, as shown in the exemplary FIGS. 22-26.

Referring now to the exemplary FIGS. 27-28, in some embodiments, base 12 can include an opening 20 for receiving a toggle lever 47. In some embodiments, the temperature indicating means can include at least one thermochromic magnet 77 having at least two colors that correspond to at least two temperature ranges. For example, magnet 77 may be silver in color when it has a temperature of below 110 degrees Fahrenheit and green in color when it has a temperature of above 110 degrees. In other examples, magnet 77 may be silver in color when its temperature is below 72 degrees, yellow when its temperature is between 72 and 110 degrees, and green when its temperature is greater than 110 degrees. In some embodiments, magnet 77 may further be configured for temporary engagement with the wall fixture 16. For example, magnet 77 may protrude slightly from base 12 such that it can be placed in direct contact with metallic portion 48 of electronic wall fixture 46. It is to be appreciated that magnet 77 may be configured to correspond to a single portion of opening 20, multiple portions of opening 20, or as shown in the example of FIGS. 14 and 23, the magnet may surround all sides of opening 20.

In other embodiments, and as shown in the exemplary depictions of FIGS. 30 and 32, the temperature indicating means can include a thermocouple 71. In some embodiments, thermocouple 71 can have at least two states that correspond to at least two temperature ranges. For example, thermocouple can have a first state corresponding to a temperature range below 70 degrees, a second state corresponding to a temperature range between 70 and 85 degrees, a third state corresponding to a temperature range of between 85 and 100 degrees, a fourth state corresponding to a temperature range of between 100 and 110 degrees, and a fifth state corresponding to a temperature range greater than 110 degrees. It is to be appreciated that the thermocouple can have any number of states suitable for indicating temperature ranges corresponding to overheated electrical wall fixtures.

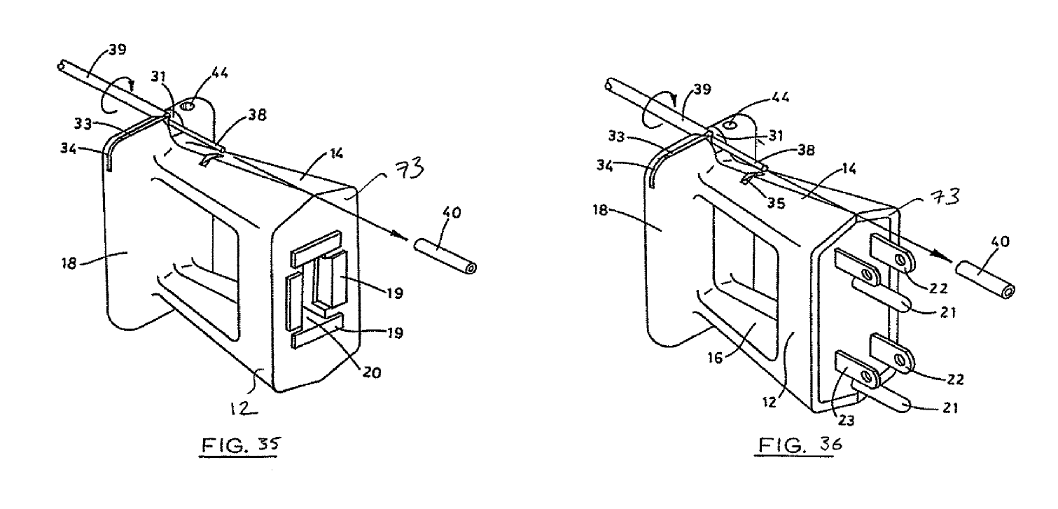

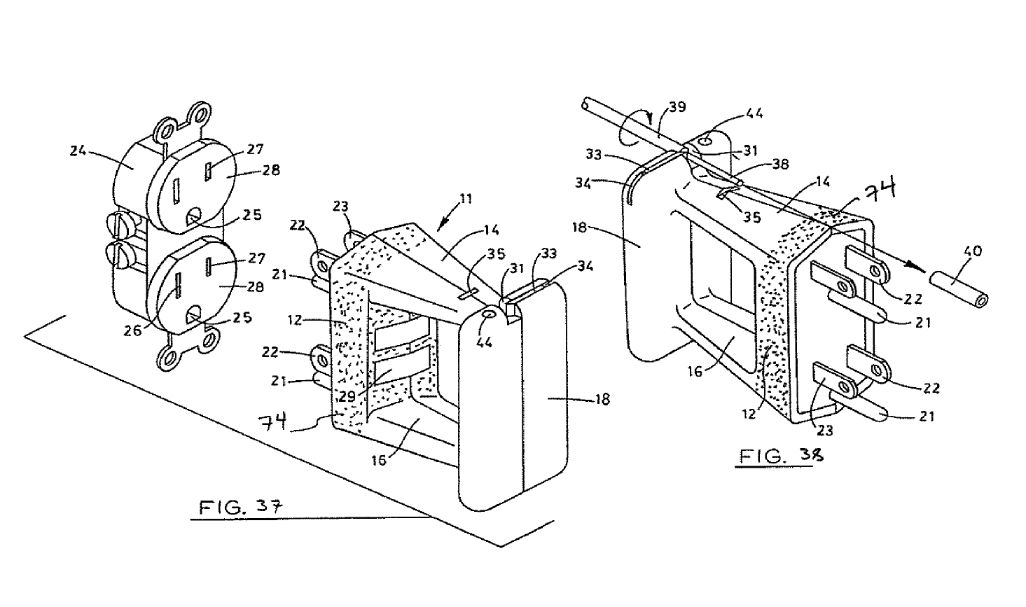

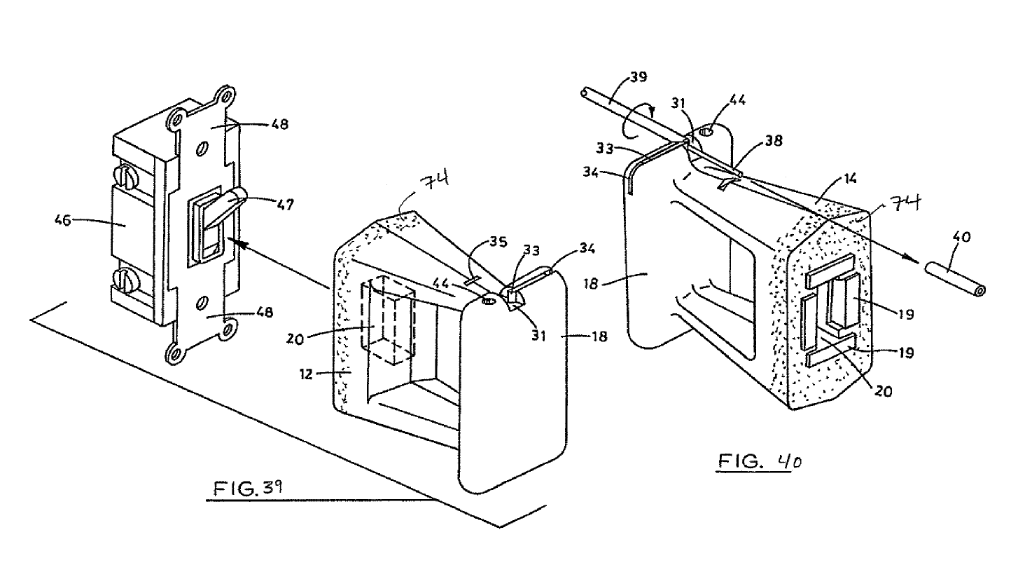

In some embodiments, and as shown in the examples of FIGS. 29 to 32, thermocouple 71 can be configured so that contacts the wall fixture when the device is temporarily engaged therewith. For example, and referring specifically to the example of FIGS. 29 and 30, thermocouple 71 can be located on a portion of base 12 such that when the device is temporarily attached to electrical wall fixture 24, the thermocouple can make physical contact with socket 28 or any other exposed portion of wall fixture 24. In another example, thermocouple 71 can be configured to contact a portion 81 of wall fixture 24 between the sockets 28. In other embodiments, and referring to the example of FIGS. 31 and 32, thermocouple 71 can be located on a portion of base 12 so as to make contact with metallic portion 48 of wall fixture 46. In one example, a spring (not shown) may be included in base 12 for applying force to thermocouple 71 so as to ensure contact with a wall fixture 46. In other embodiments, thermocouple 71 can be configured so as to contact a plastic cover portion (not shown) of the electrical wall fixture.

In other embodiments, and as shown in the example of FIG. 34, base 12 can include two sets of conductive prongs 21, 22, and 23 for temporary engagement with a pair of sockets 25, 26, and 27 of electrical wall fixture 24. In some embodiments, thermocouple 72 can be configured so as to contact at least one of said conductive prongs. In one example, thermocouple 72 may be disposed inside base 12 and configured so as to contact a portion of conductive prong 22, the portion also disposed inside base 12.

It is to be appreciated that any number and configuration of thermocouples may be included in the device. For example, one thermocouple may be provided inside the base (as shown in the example of FIG. 34) and another thermocouple along with a spring may be provided on a portion of base 12 (as shown in the example of FIG. 30).

In some embodiments, the temperature indicating means can include a temperature indicator selected from the group consisting of a lighted signal, an audio signal, a liquid crystal display, a meter, and combinations thereof. As shown in the exemplary FIGS. 29-31, temperature indicator 75 can be provided on a portion of the base, support arm, or hand grip. Temperature indicator 75 can be included in an electrical circuit which also includes thermocouple 71/72, and can be configured to indicate at least one of the states of the thermocouple 71/72. For example, temperature indicator 75 may be an LED which is activated when the thermocouple 71/72 has a temperature exceeding 110 Fahrenheit. In another example, the temperature indicator may be a meter and configured to display the temperature of the thermocouple 71/72.

In other embodiments, the apparatus can include an electricity sensor for detecting whether the wall fixture is energized and an indicator for indicating a state of said electricity sensor and a state of said thermocouple. As discussed above, and as shown in the examples of FIGS. 6-10, an electricity sensor can include prongs 22 and 23 connected to an indicator 29. In some embodiments, and as shown in the example of FIGS. 33 and 34, indicator 76 can be configured to indicate both whether the wall fixture 24 is energized and a temperature of the wall fixture 24. In some embodiments, indicator 76 can be selected from the group consisting of a lighted signal, an audio signal, a liquid crystal display, a meter, and combinations thereof. For example, indicator 76 may be a single LED which is illuminated when the wall fixture 24 is energized and below 110 degrees Fahrenheit. In another example, indicator 76 may be a liquid crystal display configured to indicated (i) whether the wall fixture 24 is energized and (ii) the temperature range as sensed by the thermocouple 72.

In other embodiments, the temperature indicating means can include a thermochromic liquid crystal adhesive strip having at least two colors that correspond to at least two temperature ranges. In some embodiments, the thermochromic liquid crystal adhesive strip can be affixed to a portion of the base. As shown in the example of FIG. 35, liquid crystal adhesive strip 73 may be affixed to, and configured to cover a substantial portion of, base 12. The strip 73 can be located on a portion of base 12 such that when the manipulation device is temporarily fixed to the wall fixture, strip 73 is placed in direct contact with the wall fixture. In other embodiments, and as shown in the example of FIG. 36, liquid crystal adhesive strip 73 can be placed on less than a substantial portion of base 12. In such embodiments, the liquid crystal adhesive strip 73 should be placed in a location towards the peripheral edge of base 12. In some embodiments, liquid crystal adhesive strip 73 can be configured to have two colors corresponding to two temperature ranges. For example, when the liquid crystal adhesive strip 73 is below 72 degrees Fahrenheit, it can be black in color, when it is between 72 and 110 degrees Fahrenheit it can be yellow in color, and when it is above 110 degrees Fahrenheit, it can be green in color.

In some embodiments, the temperature indicating means can include a thermochromic compound having at least two colors that correspond to at least two temperature ranges. In some embodiments, the thermochromic compound can be embedded in a portion of the insulated base. In other embodiments, the thermochromic compound can be embedded in a portion of the support arm or the hand grip. In alternative embodiments, the thermochromic compound can be applied to a portion of the insulated base. In other embodiments, the thermochromic compound can be applied to a portion of the support arm or the hand grip. Referring to the examples of FIGS. 37-40, the thermochromic compound 74 can be a polymer, dye, or pigment embedded in, or applied to, the insulated base 12. It is to be appreciated that the thermochromic compound 74 can additionally be embedded in a portion of support arms 14 and hand grip 18. Analogous to the embodiments including a liquid crystal adhesive strip, the thermochromic compound 74 can have at least two colors corresponding to at least two temperature ranges. For example, the thermochromic compound can be orange when the temperature of the base 12 is below 110 degrees Fahrenheit and green when the temperature is above 110 degrees.

In other embodiments, and as shown in the examples of FIGS. 35 and 36, a device for maintaining an electrical wall fixture can include an insulated base 12 having a means for temporarily engaging said apparatus to the electrical wall fixture (for example, magnets 19 as shown in FIG. 35 or conductive prongs 21-23 as shown in FIG. 36), an insulated hand grip 18 coupled to base 12 by at least one support arm 14, a measuring indicia 35 for use in determining the length of an electrical wire to be stripped, a wire stripping slot 31 and a replaceable blade 33 provided adjacent to slot 31 such that a sharp edge of blade 33 partially protrudes into slot 31 for engagement with an insulated sleeve of the electrical wire, a hole 44 that is available and sized to accommodate receipt of the electrical wire for use in bending the electrical wire, and a means (not shown) for indicating whether the electrical wall fixture is energized. In some embodiments, the device may additionally include a means for indicating the temperature of the electrical wall fixture. As shown in the example of FIGS. 35 and 36, the temperature indicating means can be a liquid crystal adhesive strip 73. However, in accordance with the above description, the temperature indicating means can include a thermochromic magnet, a thermocouple, a thermochromic liquid crystal adhesive strip, a thermochromic compound, and combinations thereof.

In other embodiments of the present invention, a method for testing an electrical wall fixture using an apparatus including an insulated base having a means for temporarily attaching the apparatus to the electrical wall fixture, an insulated hand grip coupled to the base, and a means for indicating the temperature of the electrical wall fixture, can include: (i) orienting the apparatus with respect to the electrical wall fixture by moving the insulated hand grip and temporarily attaching the apparatus to the electrical wall fixture, (ii) waiting for a time interval, and (iii) observing the means for indicating the temperature of the electrical wall fixture to determine whether the electrical wall fixture has deteriorated. For example, and with reference to the examples of FIGS. 35 and 36, the apparatus can be oriented with respect to the electrical wall fixture by the user grasping and moving hand grip 18 and temporarily attaching (via magnets 19 as shown in FIG. 35 or conductive prongs 21-23 as shown in FIG. 36) the apparatus to the wall fixture. Once the device is temporarily attached to the wall fixture, the user can wait a period of time to allow the temperature indicating means (for example, liquid crystal adhesive strip 73 as shown in FIGS. 35 and 36, thermochromic compound 74 as shown in FIGS. 37-40, thermocouple 71 as shown in FIGS. 28 and 32, thermocouple 72 as shown in FIG. 34, or magnet 77 as shown in FIG. 28) to equalize in temperature. In some examples, the time interval can be between 5 and 20 seconds, in other examples, the time interval can be over 20 seconds. The temperature indicating means can then be observed and it can be determined there from if the electrical wall fixture has deteriorated. In one example, a user can observe the temperature indicating means to determine whether the electrical wall fixture has a temperature exceeding 110 degrees Fahrenheit.

In other embodiments, the apparatus can further include a means for indicating whether the electrical wall fixture is energized. For example, and referring to the example of FIG. 29, the apparatus can include an electricity sensor (not shown) and indicator 29. In some embodiments, the method can further include the step of observing the means for indicating whether the electrical wall fixture is energized (for example, indicating means 29) to assess the safety of performing maintenance on the electrical wall fixture.

In some embodiments, the apparatus can further include at least one set of conductive prongs thereon (for example, conductive prongs 21-23). In some embodiments, the step of temporarily attaching the apparatus to the electrical wall fixture can include inserting all of the conductive prongs into corresponding slots on the electrical wall fixture. In other embodiments, and referring to the example of FIGS. 31-32, the apparatus can further include at least one opening for receiving a toggle lever of said electrical wall fixture (for example, opening 20) and at least one magnet (for example, magnet 19). In some embodiments, the step of temporarily attaching the apparatus to the electrical wall fixture can include temporarily attaching the magnet to a metallic surface (for example, surface 48) of the electrical wall fixture such that said toggle lever of the electrical wall fixture fits into the opening.

In other embodiments, the method of maintaining an electrical wall fixture can further include the initial step of removing an insulated cover plate from the electrical wall fixture.

In some embodiments, a method of installing an electrical wall fixture using an apparatus including an insulated base having a means for temporarily attaching the apparatus to the electrical wall fixture, an insulated hand grip coupled to the base, and a means for indicating the temperature of the electrical wall fixture, can include the steps of: (i) temporarily attaching the apparatus to the electrical wall fixture, (ii) causing at least one electrical wire to be secured against a portion of the electrical wall fixture, (iii) placing the electrical wall fixture within a junction box disposed in a wall, (iv) energizing the at least one electrical wire, (v) waiting for a time interval, (vi) observing the means for indicating the temperature of the electrical wall fixture to determine whether the electrical wall fixture has a temperature exceeding a threshold; and if the temperature exceeds a threshold, (vii) deenergizing the at least one electrical wire, removing the electrical wall fixture from the junction box, and causing the at least one electrical wire to be detached from the portion of the electrical wall fixture. For example, and referring to the exemplary diagrams of FIGS. 31-32, the apparatus can be temporarily attached to electrical wall fixture 46. An electrical wire (not shown) can be secured against a portion 85 of the wall fixture 46. Next, the wall fixture 46 can be placed in a junction box within a wall. The electrical wire(s) can be energized so as to electrically activate the wall fixture 46. Next, the user can wait for a time interval. In one example, the time interval can be 20 seconds. In other examples, the time interval can be greater than 20 seconds. The time interval should be sufficient so as to allow the wall fixture 46 to achieve electrical and thermal equilibrium.

Once the time interval has passed, the user can observe the temperature indicating means (for example, indicator 75) and determine if the wall fixture has a temperature greater than a threshold. For example, indicator 75 may be configured to indicate a temperature of greater than 110 degrees Fahrenheit. If the wall fixture has a temperature exceeding the threshold, it can be deduced that the wall fixture has deteriorated or there was a mistake in installing the wall fixture.

For example, the electrical wires affixed to the wall fixture may not be secured, or may be reverse polarized. In this case, the electrical wire can be deenergized, the wall fixture can be removed from the junction box, and the wire can be detached from the wall fixture.

In other embodiments, if the temperature does not exceed the threshold, it can be deduced that the wall fixture has not deteriorated and that the installation is proper, and the device can be detached from the wall fixture. For example, a user can grasp the hand grip and pull it from the wall fixture, thus disengaging the magnet 19 from the magnetic plate 48 (as shown in the example of FIGS. 31-32) or disengaging the conductive prongs 21-23 (as shown in the example of FIGS. 33-34).

In some embodiments, and as shown in the examples of FIGS. 35 and 36, the apparatus can further include a wire stripping slot 31 and a replaceable blade 33 provided adjacent to the slot 31 such that a sharp edge of the blade 33 partially protrudes into the slot 31 for engagement with an insulated sleeve of at least one electrical wire. In some embodiments, the method can further include the step of removing a portion of the insulated sleeve by placing at least one electrical wire in the wire stripping slot, engaging the insulated sleeve with the blade, and removing the at least one electrical wire from the wire stripping slot.

It is to be understood that variations and modifications of the present invention may be made without departing from the scope thereof. For example, the disclosed methods of maintaining an electrical wall fixture and the disclosed methods of installing an electrical wall fixture can be applied to an electrical wall socket, electrical wall switch, or other type and configurations of wall fixtures. It is also to be understood that the present invention is not to be limited by the specific embodiments disclosed herein, but only in accordance with the appended claims when read in light of the foregoing specification.

What is claimed is:

1. An apparatus for maintaining an electrical wall fixture comprising:
an insulated base having a means for temporarily attaching said apparatus to said electrical wall fixture;
an insulated hand grip coupled to said base; and
a means for indicating the temperature of said electrical wall fixture.

2. The apparatus of claim 1, wherein said base comprises an opening for receiving a toggle lever.

3. The apparatus of claim 2, wherein said temperature indicating means comprises at least one thermochromic magnet having at least two colors that correspond to at least two temperature ranges, said magnet further configured for temporary engagement with said wall fixture.

4. The apparatus of claim 1, wherein said temperature indicating means comprises a thermocouple having at least two states that correspond to at least two temperature ranges.

5. The apparatus of claim 4, wherein said thermocouple is configured so as to contact said wall fixture when said apparatus is temporarily engaged with said wall fixture.

6. The apparatus of claim 4, wherein said base comprises two sets of conductive prongs thereon for temporary engagement with a pair of sockets of said wall fixture and said thermocouple is configured so as to contact at least one of said conductive prongs.

7. The apparatus of claim 4, wherein said temperature indicating means further comprises a temperature indicator selected from the group consisting of a lighted signal, an audio signal, a liquid crystal display, a meter, and combinations thereof.

8. The apparatus of claim 4, further comprising an electricity sensor for detecting whether the wall fixture is energized and an indicator for indicating a state of said electricity sensor and a state of said thermocouple, wherein said indicator is selected from the group consisting of a lighted signal, an audio signal, a liquid crystal display, a meter, and combinations thereof.

9. The apparatus of claim 1, wherein said temperature indicating means comprises a thermochromic liquid crystal adhesive strip having at least two colors that correspond to at least two temperature ranges, said thermochromic liquid crystal adhesive strip affixed to a portion of said base.

10. The apparatus of claim 1, wherein said temperature indicating means comprises a thermochromic compound having at least two colors that correspond to at least two temperature ranges.

11. The apparatus of claim 1, wherein said temperature indicating means is configured to indicate a temperature of between about 72 and 100 degrees Fahrenheit.

12. An apparatus for maintaining an electrical wall fixture comprising:
an insulated base having a means for temporarily engaging said apparatus to said electrical wall fixture;
an insulated hand grip coupled to said base by at least one support arm;
a measuring indicia for use in determining the length of an electrical wire to be stripped;
a wire stripping slot and a replaceable blade provided adjacent to said slot such that a sharp edge of said blade partially protrudes into said slot for engagement with an insulated sleeve of said electrical wire;
a hole that is available and sized to accommodate receipt of said electrical wire for use in bending said electrical wire;
a means for indicating whether said electrical wall fixture is energized; and
a means for indicating the temperature of said electrical wall fixture, said means comprising one of the group consisting of a thermochromic magnet, a thermocouple, a thermochromic liquid crystal adhesive strip, a thermochromic compound, and combinations thereof.

13. A method for testing an electrical wall fixture using an apparatus comprising an insulated base having a means for temporarily attaching said apparatus to said electrical wall fixture, an insulated hand grip coupled to said base, and a means for indicating the temperature of said electrical wall fixture, comprising:
orienting said apparatus with respect to said electrical wall fixture by moving said insulated hand grip and temporarily attaching said apparatus to said electrical wall fixture;
waiting for a time interval; and
observing said means for indicating the temperature of said electrical wall fixture to determine whether said electrical wall fixture has deteriorated.

14. The method of claim 13, wherein said apparatus further comprises a means for indicating whether said electrical wall fixture is energized, and said method further comprising observing said means for indicating whether said electrical wall fixture is energized to assess the safety of performing maintenance on said electrical wall fixture.

15. The method of claim 13, wherein said apparatus further comprises at least one set of conductive prongs thereon, and wherein said step of temporarily attaching said apparatus to said electrical wall fixture comprises inserting all of said conductive prongs into corresponding slots on said electrical wall fixture.

16. The method of claim 13, wherein said apparatus further comprises at least one opening for receiving a toggle lever of said electrical wall fixture and at least one magnet, and wherein said step of temporarily attaching said apparatus to said electrical wall fixture comprises temporarily attaching said magnet to a metallic surface of said electrical wall fixture such that said toggle lever of said electrical wall fixture fits into said at least one opening.

17. The method of claim 13, further comprising the initial step of removing an insulated cover plate from said electrical wall fixture.

18. A method of installing an electrical wall fixture using an apparatus comprising an insulated base having a means for temporarily attaching said apparatus to said electrical wall fixture, an insulated hand grip coupled to said base, and a means for indicating the temperature of said electrical wall fixture, comprising:
temporarily attaching said apparatus to said electrical wall fixture;
causing at least one electrical wire to be secured against a portion of said electrical wall fixture;
placing said electrical wall fixture within a junction box disposed in a wall;
energizing said at least one electrical wire;
waiting for a time interval;
observing said means for indicating the temperature of said electrical wall fixture to determine whether said electrical wall fixture has a temperature exceeding a threshold; and
if said temperature exceeds a threshold, deenergizing said at least one electrical wire, removing said electrical wall fixture from said junction box, and causing said at least one electrical wire to be detached from said portion of said electrical wall fixture.

19. The method of claim 18, further comprising the step wherein if said temperature does not exceed a threshold, detaching said apparatus from said electrical wall fixture.

20. The method of claim 18, wherein said apparatus further comprises a wire stripping slot and a replaceable blade provided adjacent to said slot such that a sharp edge of said blade partially protrudes into said slot for engagement with an insulated sleeve of said at least one electrical wire, said method further comprising the step of removing a portion of said insulated sleeve by placing said at least one electrical wire in said wire stripping slot, engaging said insulated sleeve with said blade, and removing said at least one electrical wire from said wire stripping slot.
